(19) United States
(12) Patent Application Publication
(10) Pub. No.: US 2014/0059513 A1
(43) Pub. Date: Feb. 27, 2014

(54) Creation and Uploading of Archives for Software Projects to Submission Portal

(71) Applicant: Sean Alexander Sabo, Port Townsend, WA (US)

(72) Inventor: Sean Alexander Sabo, Port Townsend, WA (US)

(73) Assignee: Bank of America, Charlotte, NC (US)

(21) Appl. No.: 13/595,034

(22) Filed: Aug. 27, 2012

(51) Int. Cl. G06F 9/44

(52) U.S. Cl. 717/101

(57) ABSTRACT

A computer system interacts with a software development environment to enable a software developer to submit one or more software projects to a submission portal for analysis. A processor obtains needed files associated with a software project and then may proceed to compile the artifacts based on compile parameters in order to generate additional artifacts typically containing at least one binary file but that may be dependent on a type of the software project. The configuration data may be created independently of a build environment of the software project. The computer system may then archive artifacts of the software project that may be compressed and uploaded to an analysis tool. The submissions portal can then determine whether the submitted code is complete. The submitted code can be further analyzed by a static analysis engine, where the results are presented to the developer.

### FIELD

Aspects described herein relate to a computer system that facilitates submission of artifacts of a software project to a submission portal for analysis.

### BACKGROUND

A business often utilizes software applications for business operations, spanning mobile applications, web pages, and so forth. However, the creation and maintenance of a software project may involve numerous software inputs. A software developer typically develops the software project in an integrated development environment. In order to verify the software project before presenting it for commercial use, the software elements (e.g., source code, executable files, test plans, and/or documentation which may be referred as artifacts) of the software project may be checked for completeness and accuracy. To do so, the software inputs may be submitted by the developer to an analysis engine. The developer subsequently receives results from the analysis engine and can update the software project based on the results.

Before a software project is submitted to the analysis engine, different software inputs may be processed differently and assembled into one or more archives that are subsequently uploaded to the analysis engine. The above procedure often requires numerous operations that are prone to error. Any technique that facilitates the submission procedure for the software developer would be beneficial.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses in which a software module (such as a plug-in) interacts with a software development environment to enable a software developer to submit one or more software projects to a submission portal for analysis. The analysis engine can then determine whether the submitted code is free from detectable potential defects. The module enables the developer to upload source and binary files to a submission portal to initiate the analysis.

The submissions portal determines whether all of the necessary dependencies are included. If not, the submissions portal may provide information about the discrepancies. If so, the submission may be committed so that the code can be analyzed by a static analysis engine. The results of the analysis may become available to the developer through a web interface.

According to one or more aspects, a software project is submitted for analysis. A processor obtains needed files associated with a software project (typically including source code, configuration files, and any additional needed files) and then may proceed to compile the artifacts based on compile parameters in order to generate additional artifacts typically containing at least one binary file but that may be dependent on a type of the software project. The configuration data (that may include compile parameters) may be created independently of a build environment of the software project. The processor then may archive artifacts of the software project that can be uploaded to an analysis tool.

According to one or more aspects, a script may be generated to automate the process of submitting one or more software projects to verify that the submission is free from detectable potential defects. The script can then be executed in order to repeat the process without again re-entering configuration information through the plug-in.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be implemented as computer-readable instructions stored on a computer-readable medium, such as a non-transitory computer-readable medium. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the disclosure will occur to persons of ordinary skill in the art from a review of this disclosure. For example, one of ordinary skill in the art will appreciate that the steps illustrated herein may be performed in other than the recited order, and that one or more steps illustrated may be optional in accordance with aspects of the disclosure.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a suitable computing system environment that may be used according to one or more illustrative embodiments.

FIG. 2 shows an illustrative system for implementing example embodiments according to one or more aspects of the present disclosure.

FIG. 3 illustrates a system for verifying artifacts for a software project according to one or more aspects of the present disclosure.

FIG. 4 illustrates a process for verifying artifacts for a software project according to one or more aspects of the present disclosure.

FIG. 5 shows a mapping between projects supported at a development system and at a submission portal according to one or more aspects of the present disclosure.

FIG. 6 illustrates a client-server relationship between an integrated development environment and an analysis tool that analyzes artifacts according to one or more aspects of the present disclosure.

FIG. 7 illustrates a screenshot for creating artifacts for submission for analysis according to one or more aspects of the present disclosure.

FIG. 8 illustrates a screenshot for creating an archive for artifacts according to one or more aspects of the present disclosure.

FIG. 9 illustrates a screenshot for creating an archive for a software project according to one or more aspects of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

In accordance with various aspects of the embodiments, a computer-executable component facilitates the submission of project elements for analysis by a developer working in a software development environment. The developer provides input data that identifies selected software projects and describes processing of project elements in order to properly submit the software projects for analysis. The input data is preserved so that configuration information does not need to be re-entered if the selected software projects are subsequently submitted for verification using the computer-executable component. Furthermore, scripts may be generated to automate the process of submitting the software projects for verification without using the computer-executable component.

A module (such as a plug-in) may interact with a software development environment that enables a software developer to submit one or more software projects to a submission portal for analysis. The analysis can then verify the submitted code for completeness and accuracy. The software projects may be scanned without having to maintain the scan configuration in the developer's build environment. The module enables the developer to upload source and binary files to a submission portal to initiate the analysis.

The submissions portal determines whether all of the necessary dependencies are included. If not, the submissions portal may provide information about the discrepancies. If so, the submission may be committed so that the code can be analyzed by a static analysis engine. The results of the analysis may become available to the developer through a web interface so that the developer can update the source files from which the archives were generated.

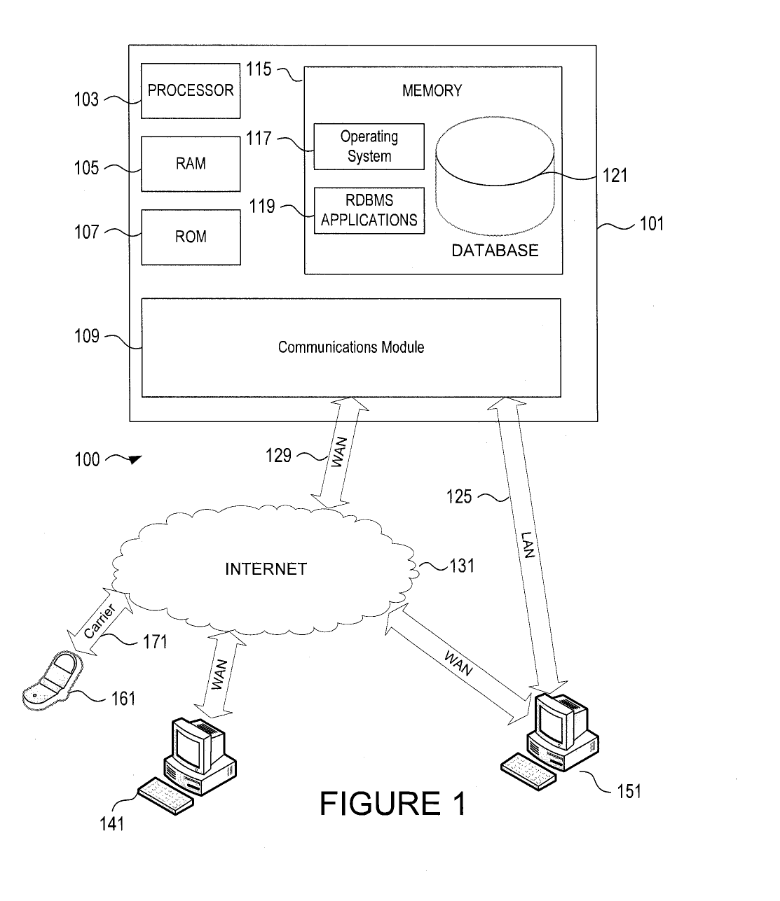

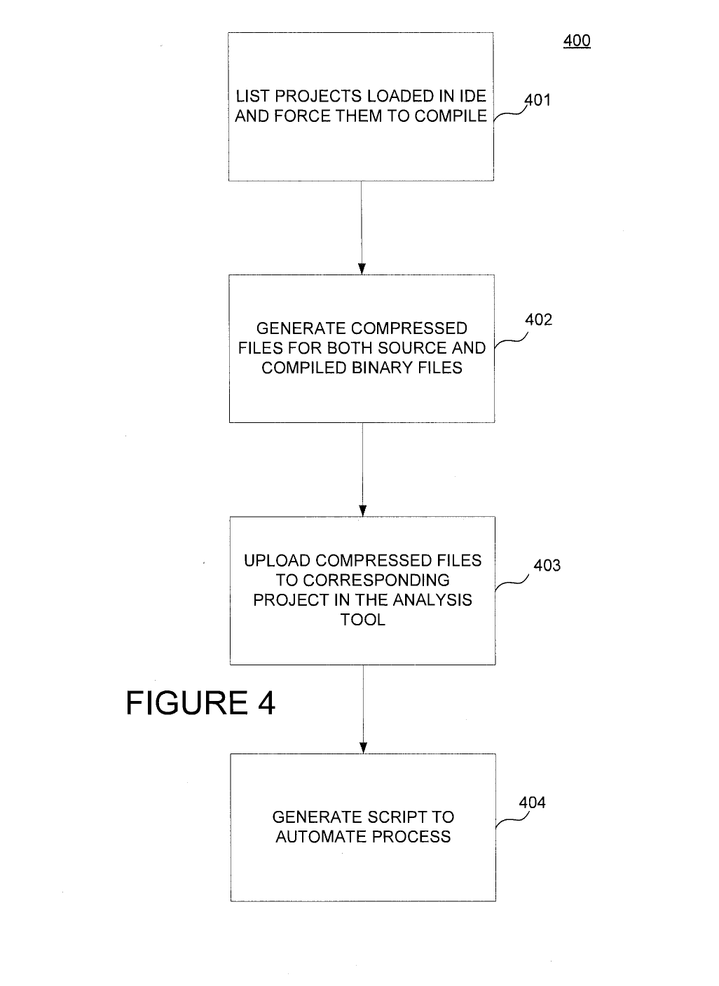

FIG. 1 illustrates an example of a suitable computing system environment 100 that may be used according to one or more illustrative embodiments. For example, as will be further discussed, computing system environment 100 may support process 400 as shown in FIG. 4 to support a financial transaction system. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence and receipts to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 125 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

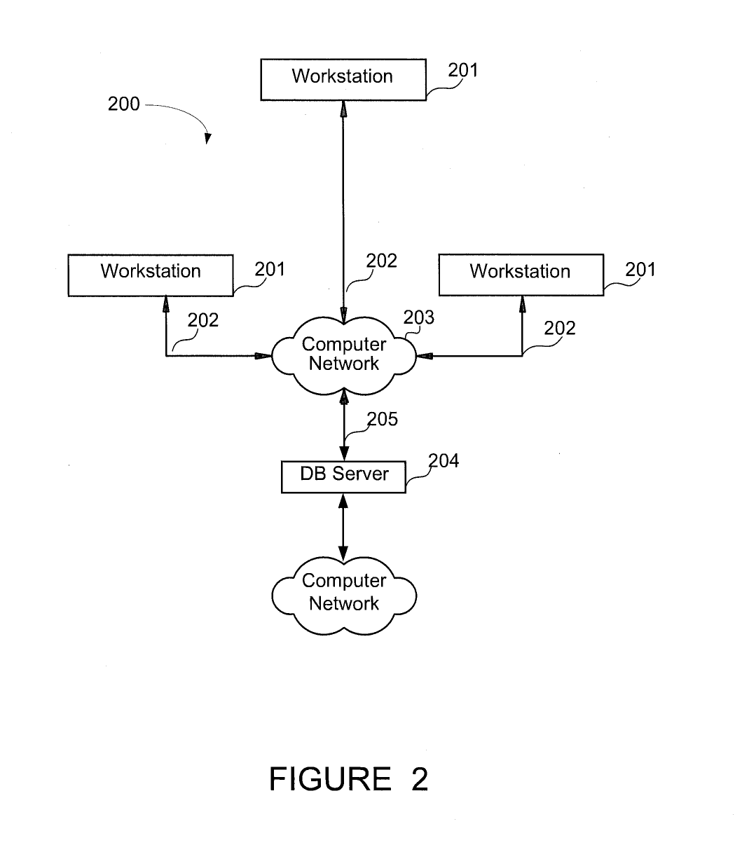

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links.

The steps that follow in the Figures may be implemented by one or more of the components in FIGS. 1 and 2 and/or other components, including other computing devices.

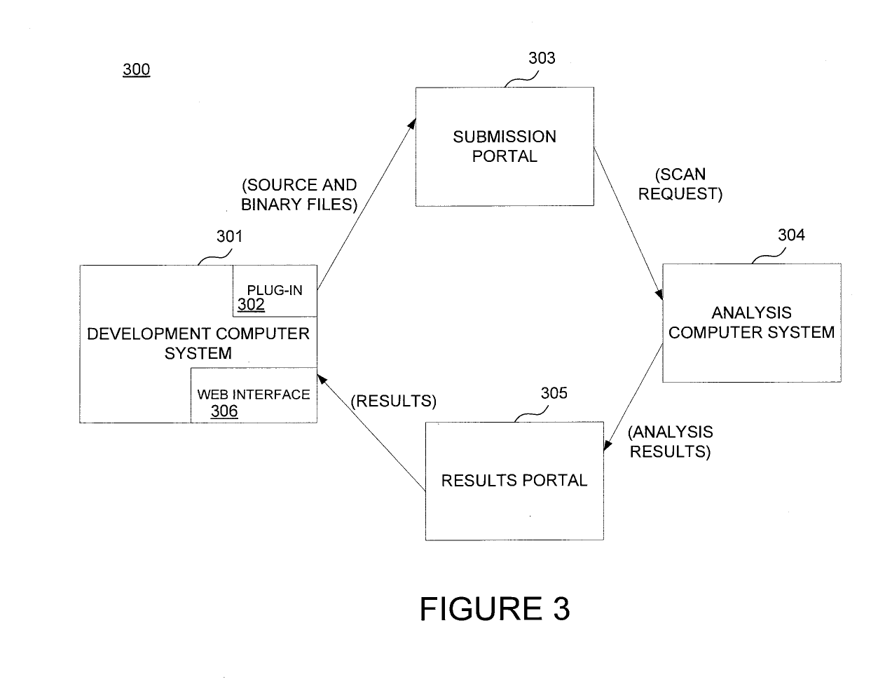

FIG. 3 illustrates system 300 for verifying artifacts of a software project according to one or more aspects of the present disclosure. An artifact may be any element in a software development project and may include documentation, test plans, images, data files and executable modules. For example, an artifact may comprise source code, binary files obtained or compiled from the source code, and/or dependent libraries, among other items.

A software project may be directed to achieving a business objective or function. For example, a software project may be directed to a mobile application providing one or more web pages for customer on-line account status and billing. A software project may include one or more binary files containing computer-executable instructions that execute on a host computer system to support the project's objective. In addition, a software project may include source files that can be compiled to obtain the binary files as well as text files (typically in the form of source files) and/or library files that are referenced by the source files.

Development computer system 301 provides a software developer an integrated development environment (IDE) that may be used to develop console and graphical user interface applications along with mobile applications, web sites, web applications, and web services in both native code together with managed code for different platforms.

Development computer system 301 may include a code editor as well as an integrated debugger that may function both as a source-level debugger and a machine-level debugger. Other built-in tools may include a forms designer for building graphical user interface (GUI) applications, web designer, class designer, and database schema designer.

Development computer system 301 may support different programming languages by means of language services, which allow the code editor and debugger to support (to varying degrees) nearly any programming language, provided a language-specific service exists.

Development computer system 301 may accept one or more plug-ins that enhances the functionality of system 301. With some embodiments, a plug-in may be implemented by computer-readable instructions (sometimes referred to as software) and/or plug-in hardware module. As will be further discussed, an embodiment of the disclosure may support plug-in 302 that assists with the creation and uploading of the submission archives to submission portal 303 from development computer system 301.

Plug-in 302 interfaces with submission portal 303. A software developer may log into submission portal 303 and create a submission for a software project by uploading artifacts necessary for scanning (e.g., source code, binaries, and dependent libraries). Submission portal 303 then determines if the necessary dependencies are included in the submission and may provide the developer hints as to which components are missing. With some embodiments, plug-in 302 accordingly receives information from submission portal 303.

When the developer is satisfied with the completeness of the submission, the developer may then commit the submission.

After the submission is committed, submission portal 303 initiates analysis of the submitted code by analysis computer system 304. Analysis system 304 may comprise a static analysis engine that verifies the software's potential detectable defects (which may be referred to as correctness) against a pre-established rule set and returns results via the results portal 305. The static analysis engine can inspect the submission for potential vulnerabilities.

Results of the analysis may be provided to the developer through results portal 305 web interface 306 for viewing on a web browser by the software developer. The results and updates of the code may be subsequently submitted to submission portal 303 for analysis.

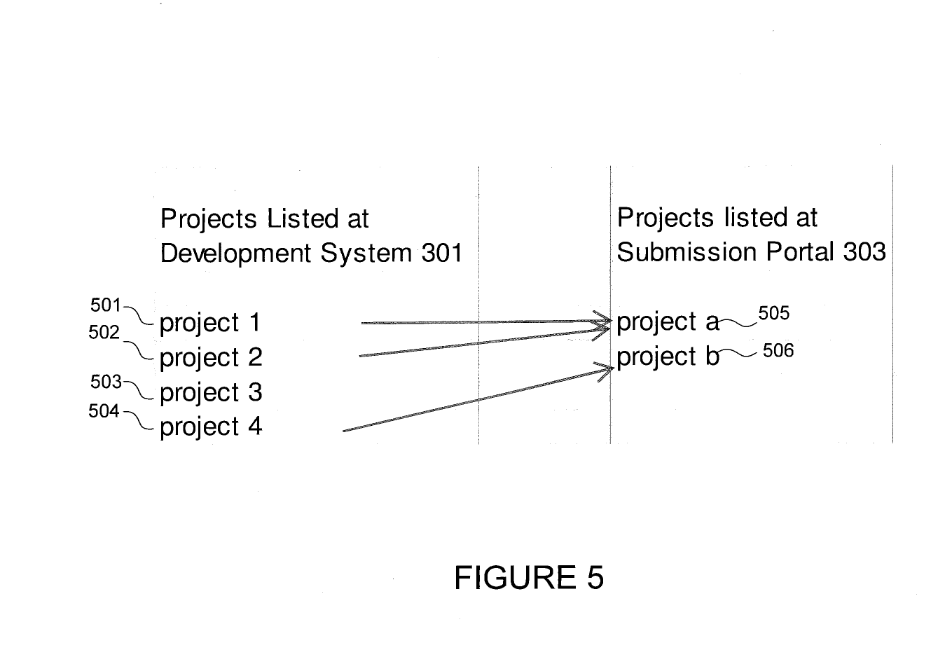

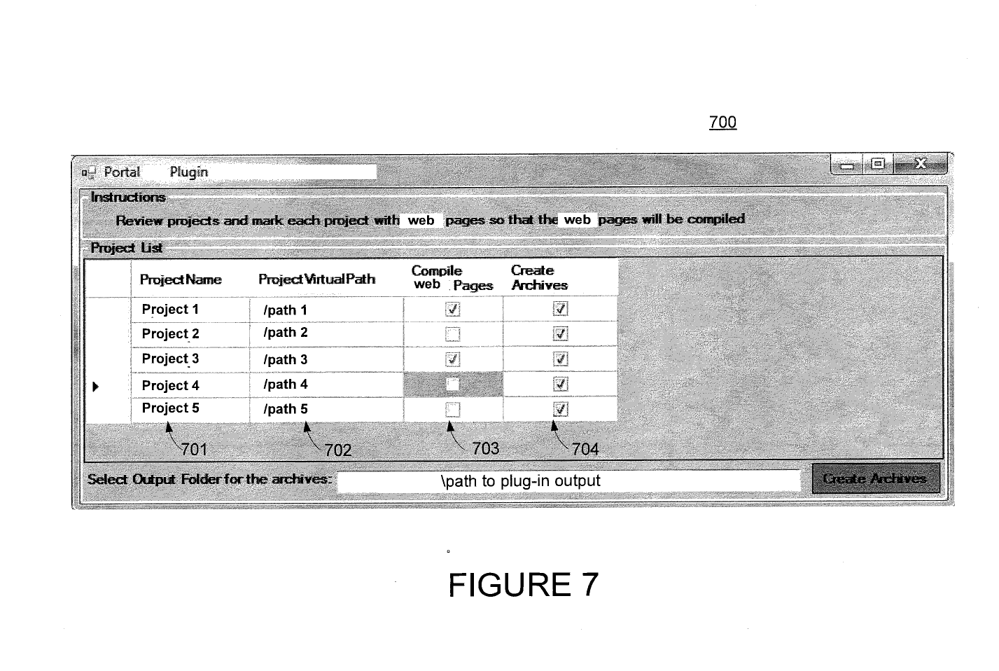

FIG. 4 illustrates process 400 for verifying artifacts for a software project according to one or more aspects of the present disclosure. At block 401 a list of software projects are loaded in the integrated development environment (IDE), for example, as shown as list 701 in FIG. 7. Plug-in module 302 may triage the software project loaded in the IDE and may extract information from each software project's metadata in-order to construct a displayed listing (e.g., project virtual path 702 as shown in FIG. 7). Once the metadata, if any, has been extracted, plug-in module 302 enables a software developer to choose the software projects for which archives are created (corresponding to column 704 as shown in FIG. 7). With some embodiments, the list of software projects presented by plug-in module 302 in development computer system 301 (shown in FIG. 3) may map to a different list of software projects presented by submission portal 303. For example, as shown in FIG. 5, project 501 (project 1) and project 502 (project 2) map to project 505 (project a), project 504 (project 4) maps to project 506 (project b), while project 503 (project 3) does not map to any project at submission portal 303.

After the software projects are listed in block 401, the software projects are compiled automatically if needed. With some embodiments, plug-module 302 compiles the whole solution (which comprises one or more software projects) after screen 700 loads (as shown in FIG. 7) and then it is made available for editing by a user. As part of displaying screen 700 (the confirmation message may be asked right before this screen appears. Once the screen 700 appears, it goes through the process of compiling the whole solution with some embodiments. Once the compilation is done then the instructions “Review projects and mark each project with web pages so that the web pages will be compiled” may appear at the top of the screen)

When configuration data is indicative that one or more source files for a specified software project should have an additional compilation step performed (for example, as indicated by column 703 as shown in FIG. 7), process 400 forces the additional compilation step. For example, the specified software project may include source code providing web pages, web applications, and/or web services with dynamic code. However, embodiments may support configuration data specifying other types of processing for one or more source files associated with a software project based upon the software project type. The project type may be defined by programming language of the project and/or the manner in which the software is meant to be run (i.e., console based application, web application, windows application).

If different software projects are built against different versions of the integrated development environment, the software developer may need to take care when selecting a project and pre-compiling options. Based upon the software project properties, the plug-in module 302 may flag certain projects as needing additional procedures performed in order to properly create the archives for submission into the submissions portal. Project properties may specify the attributes of a software project's configuration. Exemplary project properties include where to put the compiled binaries, where to deploy the software too, location of files on disk, and web project's virtual path. However, not all project types may have the exact same set of project properties.

The software developer, using their knowledge of the software project, may be given some choice on what additional procedures/options need to be selected or unselected for a successful submission.

At block 402, plug-in module 302 generates compressed files for source files, compiled binary files, and/or text files and archives the files. By compressing the files, the time for transmitting the files between development computer system 301 and submission portal 303 may be reduced. In addition, with some embodiments, submission portal 303 may accept only compressed archived files.

With an embodiment, plug-in 302 creates two archive files for each software project but may be combined into one in some embodiments. (The process of making an archive file is often called archiving or packing. Reconstructing the original files from the archive is often termed unarchiving, unpacking or extracting.) One is created for source files and a second for binary files. Plug-in 302 combines source files and compresses them for the source archive file. Plug-in 302 similarly combines and compresses the binary files to form the binary archive file. However, some embodiments may create archived files without compressing the files.

At block 403, plug-in 302 uploads the archived files to analysis system 304 for a corresponding project. As previously discussed, the list of software projects presented by plug-in module 302 in development computer system 301 may map to a different list of software projects presented by submission portal 303. The compressed files are then decompressed by either submission portal 303 or analysis computer system 304.

At block 404, plug-in module 302 generates script to automate the process so that a software developer does not need to run plug-in 302 (for example, through screenshot 700 as shown in FIG. 7) when subsequently submitting a software project if the configuration data is unchanged. The script that is generated may allow the software developer to automate the process outside the context of plug-in 302.

Different embodiments may incorporate different combinations of blocks 401-404. For example, phase 1 may include only blocks 401-402 while phase 2 includes blocks 401-403 and phase 3 includes blocks 401-404.

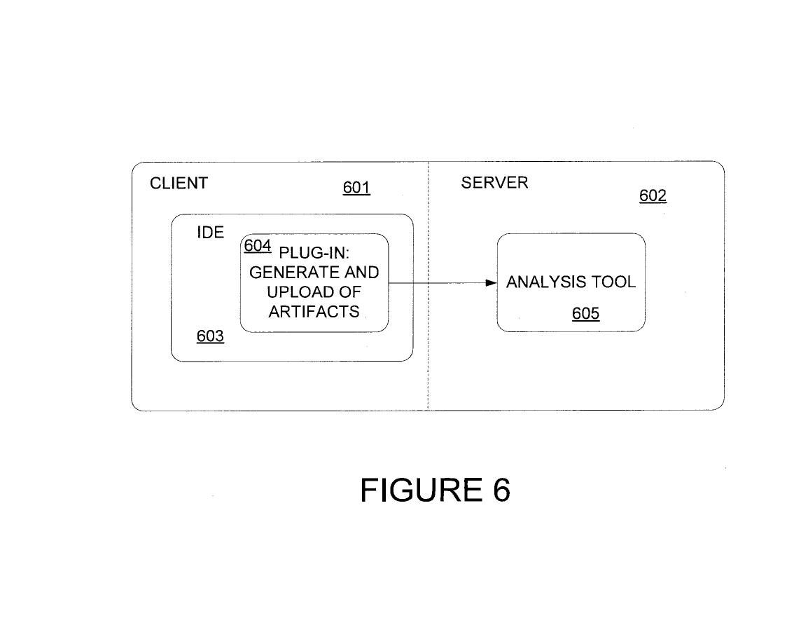

FIG. 6 illustrates a relationship between client 601 to server 602 for integrated development environment 603 and analysis tool 605 that analyzes artifacts according to one or more aspects of the present disclosure. Client 601 comprises integrated development environment 603 (corresponding to development computer system 301 as shown in FIG. 3) while server 602 comprises analysis tool 605 (corresponding to submission portal 303, analysis computer system 304, and results portal 305). Integrated development environment 603 further comprises plug-in 604 (corresponding to plug-in 302) that interacts with analysis tool 605. For example, artifacts are uploaded through plug-in 604 to analysis tool 605.

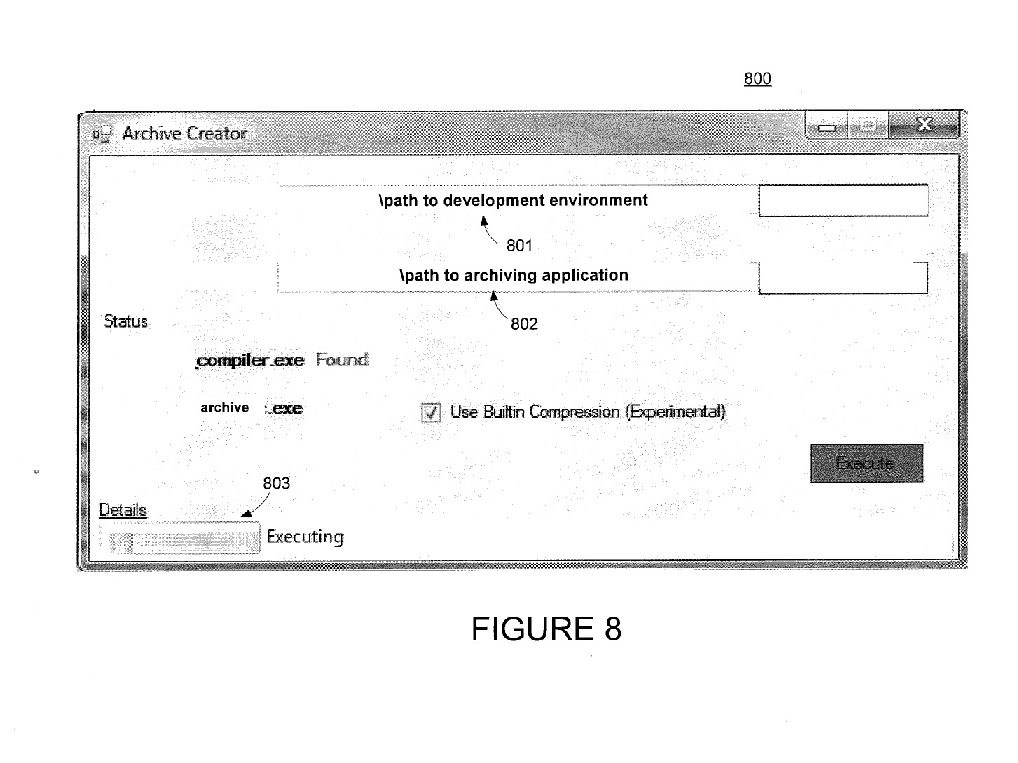

As will be discussed, FIGS. 7 and 8 show two different parts of the process to create the artifacts. FIG. 7 displays compilation selections, list of projects, additional options as needed, and a specified output folder. FIG. 8 displays specified needed paths and shows an indication of executing the process of creating the artifacts (including the additional compiling step along with creating the actual archive files).

FIG. 7 illustrates screenshot 700 for submitting artifacts for analysis in order to provide configuration information according to one or more aspects of the present disclosure. With some embodiments, column 701 lists software projects associated with a grouping of projects that may be referenced as a solution with the associated relevant project properties that may include, but not limited to, the project's virtual path as in column 702.

A software developer can indicate whether additional compilation for source code supporting web pages or any other potential special compilations should be invoked by indicating so for selected software projects (for example additional compilation support for web pages as shown in column 703). Also, the software developer can select which software projects should be archived at column 704 so that the archived files can be uploaded to analysis tool 605 (as shown in FIG. 6). One or more software projects can be selected for a solution.

FIG. 8 illustrates screenshot 800 for creating an archive for artifacts according to one or more aspects of the present disclosure. Plug-in 604 (as shown in FIG. 6) or plug-in 302 (as shown in FIG. 3) creates archived files by executing process 400 at blocks 401 and 402 (as shown in FIG. 4) using configuration information entered through screenshot 700 (as shown in FIG. 7).

Field 801 shows the path to an external tool which may be needed to perform the additional compilation while the path of the archive application, which may compress the files, is shown in field 802. As discussed previously, the source files are archived in an archive file and the binary files are archived in a separate archive file; however, the files may be merged. Field 803 shows the status (executing) of the archiving operation.

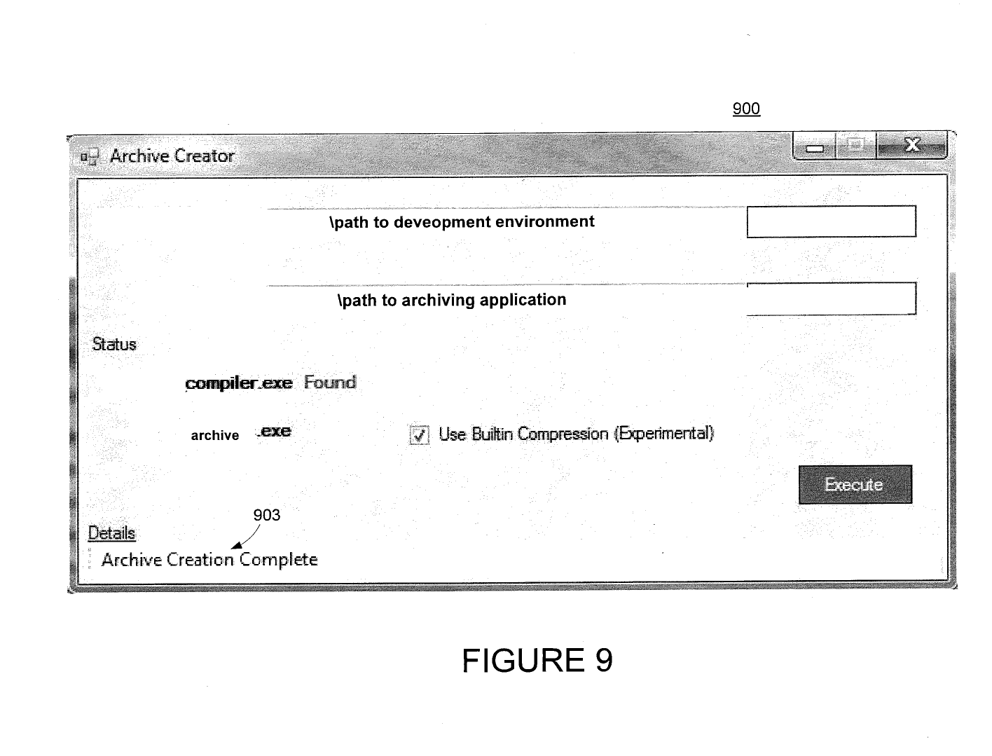

FIG. 9 illustrates screenshot 900 for creating an archive for a software project according to one or more aspects of the present disclosure. As indicated by status field 903, the archiving operation has been completed. Consequently, the archive files can then be uploaded to submission portal 303.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

What is claimed is:

1. An apparatus comprising:
at least one memory; and
at least one processor coupled to the at least one memory and configured to perform, based on instructions stored in the at least one memory:
obtaining a source file associated with a software project, the software project comprising a software application;
accessing configuration data for processing the source file;
initiating compilation for the source file when indicated by the configuration data to generate at least one binary file;
archiving a plurality of artifacts of the software project, the plurality of artifacts including the source file; and
uploading the archived files to analyze the software project.

2. The apparatus of claim 1, wherein the plurality of artifacts includes the at least one binary file.

3. The apparatus of claim 1, wherein the at least one processor is further configured to perform:
receiving an indication associated with at least one software project, the indication indicative of at least one project property;
generating the configuration data according to the indication; and
archiving the plurality of artifacts of the at least one software project from the configuration data.

4. The apparatus of claim 1, wherein the at least one processor is further configured to perform:
compressing the plurality of artifacts.

5. The apparatus of claim 1, wherein the at least one processor is further configured to perform:
generating script to repeat the obtaining, the accessing, the initiating, and the archiving for the software project.

6. The apparatus of claim 1, wherein the apparatus comprises a software plug-in module that interacts with a development environment.

7. A computer-assisted method for submitting a software project for analysis, the method comprising:
obtaining, by a processor, a source file associated with a software project, wherein the software project comprises computer-executable instructions;
accessing, by the processor, configuration data for processing the source file, the configuration data including at least one project property;
initiating, by the processor, specific processing for the source file when the specific processing is indicated by the configuration data to generate at least one binary file; and
archiving, by the processor, a plurality of artifacts of the software project, the plurality of artifacts including the source file and the at least one binary file in accordance with the configuration data.

8. The method of claim 7, wherein the initiating comprises:
initiating compilation for said one of the source file.

9. The method of claim 7, wherein the archiving comprises compressing the plurality of artifacts.

10. The method of claim 7, wherein the software project comprises a software application.

11. The method of claim 7, further comprising:
uploading, by the processor, the archived files for verification of the software project, wherein the verification verifies completeness of the plurality of artifacts.

12. The method of claim 7, further comprising:
generating script to repeat the obtaining, the accessing, the initiating, and the archiving for the software project.

13. The method of claim 7, wherein said one of the at least one source file is associated with a web page.

14. The method of claim 7, wherein the archiving comprises:
archiving the at least one binary file and the source file in different data structures.

15. The method of claim 14, further comprising:
merging the different data structures into a single data structure.

16. The method of claim 7, further comprising:
receiving an indication associated with at least one software project;
generating the configuration data according to the indication; and
archiving the plurality of artifacts of the at least one software project from the configuration data.

17. The method of claim 7, further comprising:
receiving an indication selecting at least one software project;
generating the configuration data according to the indication; and
initiating compilation of the selected at least one software project from the configuration data.

18. The method of claim 7, wherein the configuration data is created independently of a build environment of the software project.

19. The method of claim 7, wherein the configuration data is maintained independently of the build environment.

20. A non-transitory computer-readable storage medium storing computer-executable instructions that, when executed, cause a processor at least to perform operations comprising:
obtaining a source file associated with a software project, wherein the software project comprises computer-executable instructions;
accessing configuration data for processing the source file, the configuration data including at least one project property;
initiating, specified processing for one of the source file when indicated by the configuration data to obtain at least one binary file; and
archiving a plurality of artifacts of the software project, the plurality of artifacts including the source file and the at least one binary file in accordance with the configuration data.

21. The non-transitory computer-readable storage medium of claim 20, wherein the computer-executable instructions, when executed, cause the processor to perform:
uploading the archived files for analysis of the software project, wherein the analysis verifies completeness of the plurality of artifacts.

22. The non-transitory computer-readable storage medium of claim 20, wherein the computer-executable instructions, when executed, cause the processor to perform:
obtaining an indication associated with at least one software project;
generating the configuration data according to the indication; and
archiving the plurality of artifacts of the at least one software project from the configuration data.

23. The non-transitory computer-readable storage medium of claim 20, wherein the computer-executable instructions, when executed, cause the processor to perform:
initiating compilation of the source file in accordance with the configuration data.
